(19) United States
(12) Patent Application Publication
(10) Pub. No.: US 2026/0304144 A1
(43) Pub. Date: Oct. 1, 2026

(54) FAILURE PROCESSING METHOD AND APPARATUS

(71) Applicant: BEIJING XIAOMI MOBILE SOFTWARE CO., LTD., Beijing (CN)

(72) Inventors: Yi XIONG, Beijing (CN); Yumin WU, Beijing (CN)

(21) Appl. No.: 18/992,106

(22) PCT Filed: Jul. 12, 2022
(86) PCT No.: PCT/CN2022/105309

§ 371 Date: Jan. 7, 2025

(51) Int. Cl. H04W 24/02; H04W 76/20; H04W 76/30

(52) U.S. Cl. CPC H04W 24/02; H04W 76/20; H04W 76/30

(57) ABSTRACT

A failure processing method includes receiving configuration information of at least one cell or cell group sent by a network side device; reading the configuration information; determining a reading failure for the configuration information; and performing a process corresponding to the reading failure.

### CROSS-REFERENCE TO RELATED APPLICATION

This application is a U.S. national phase of International Application No. PCT/CN2022/105309, filed Jul. 12, 2022, the entire content of which is incorporated herein by reference.

### TECHNICAL FIELD

The disclosure relates to a field of communication technology, in particular to a failure processing method and a failure processing apparatus.

### BACKGROUND

In the related art, during selective activation of cell groups in multi-radio dual connectivity (MR-DC), after receiving a configuration of the selective activation of cell groups, a terminal device needs to store or update the configuration of the selective activation of cell groups in a Var variable. In order to reduce a delay of preconfigured selective activation of cell groups, when storing configuration information of a cell group to be activated, the terminal device may read configuration information in a radio resource control (RRC) reconfiguration message and store the read configuration information, thereby reducing the delay of activating the preconfigured cell group to be activated. However, it is possible that the terminal device cannot read the configuration information correctly, for example, the terminal device cannot comply with some or all the configurations included in the configuration information of the cell group.

### SUMMARY

According to a first aspect of embodiments of the disclosure, a failure processing method is provided. The method is performed by a terminal device, and includes: receiving configuration information of at least one cell or cell group sent by a network side device; reading the configuration information; determining a reading failure for the configuration information; and performing a process corresponding to the reading failure.

According to a second aspect of embodiments of the disclosure, a failure processing method is provided. The method is performed by a network side device, and includes: sending configuration information of at least one cell or cell group to a terminal device.

According to a third aspect of embodiments of the disclosure, a terminal device is provided. The terminal device includes a processor and a memory having a computer program stored thereon. The processor is configured to receive configuration information of at least one cell or cell group sent by a network side device; read the configuration information; determine a reading failure for the configuration information; and perform a process corresponding to the reading failure.

### BRIEF DESCRIPTION OF THE DRAWINGS

In order to clearly illustrate technical solutions of embodiments of the present disclosure or the background, a description of the accompanying drawings used in the embodiments of the present disclosure or the background is given below.

FIG. 1 is a schematic diagram of a communication system provided by an embodiment of the present disclosure.

FIG. 2 is a flowchart of a failure processing method provided by an embodiment of the present disclosure.

FIG. 3 is a flowchart of another failure processing method provided by an embodiment of the disclosure.

FIG. 4 is a flowchart of yet another failure processing method provided by an embodiment of the disclosure.

FIG. 5 is a flowchart of yet another failure processing method provided by an embodiment of the disclosure.

FIG. 6 is a flowchart of yet another failure processing method provided by an embodiment of the disclosure.

FIG. 7 is a flowchart of yet another failure processing method provided by an embodiment of the disclosure.

FIG. 8 is a flowchart of yet another failure processing method provided by an embodiment of the disclosure.

FIG. 9 is a flowchart of yet another failure processing method provided by an embodiment of the disclosure.

FIG. 10 is a flowchart of yet another failure processing method provided by an embodiment of the disclosure.

FIG. 11 is a flowchart of yet another failure processing method provided by an embodiment of the disclosure.

FIG. 12 is a flowchart of yet another failure processing method provided by an embodiment of the disclosure.

FIG. 13 is a schematic diagram of a communication apparatus provided by an embodiment of the disclosure.

FIG. 14 is a schematic diagram of a communication apparatus provided by an embodiment of the disclosure.

FIG. 15 is a schematic diagram of a chip provided by an embodiment of the disclosure.

### DETAILED DESCRIPTION

Embodiments of the present disclosure are described in detail below, examples of which are shown in the accompanying drawings, in which the same or similar numbers throughout represent the same or similar elements or elements with the same or similar functions. The embodiments described below with reference to the drawings are examples and are intended to explain the disclosure, and should not be construed as limiting the disclosure. In the description of the disclosure, unless otherwise stated, the character “/” means or. For example, A/B means A or B. The term “and/or” describes a relation of associated objects, which indicates three relations. For example, “A and/or B” may indicate that A exists alone, A and B both exist, and B exists alone.

In order to facilitate understanding, terms involved in the present disclosure are introduced first.

### 1. Multi-Radio Dual Connectivity (MR-DC)

The MR-DC is a generalized evolved universal terrestrial radio access (Intra-E-UTRA) dual connectivity. A terminal device may use radio resources provided by two different schedulers located on two different new radio-radio access network (NG-RAN) nodes connected via a non-ideal backhaul with one providing NR access and the other providing E-UTRA or NR access. One acts as a master node (MN), and the other acts as a secondary node (SN). The MN and the SN are connected via a network interface, and at least one MN is connected to a core network.

### 2. MR-DC with Evolved Packet Core (EPC)

E-UTRAN supports MR-DC through E-UTRA-NR DC (EN-DC). The terminal device is connected to an evolved NodeB (eNB) acting as the MN and a next generation NodeB (en-gNB) acting as the SN. The eNB is connected to the EPC through an S1 interface and to the en-gNB through an X2 interface. The en-gNB may also connect to the EPC through an S1-U interface and to other en-gNBs through an X2-U interface.

### 3. MR-DC with 5G Core (5GC)

### A) E-UTRA-NR Dual Connectivity NGEN-DC

NG-RAN supports NG-RAN E-UTRA-NR Dual Connectivity (NGEN-DC), where the terminal device is connected to an ng-eNB acting as the MN and a gNB as the SN. The ng-eNB is connected to the 5GC, and the gNB is connected to the ng-eNB through the Xn interface.

### B) NR-E-UTRA Dual Connectivity (NE-DC)

NG-RAN supports NR-E-UTRA DC (NE-DC), where the terminal device is connected to a gNB acting as the MN and an ng-eNB acting as the SN. The gNB is connected to the 5GC, and the ng-eNB is connected to the gNB via the Xn interface.

### 4. NR-NR Dual Connectivity

NG-RAN supports NR-NR DC (NR-DC), where the terminal device is connected to the gNB acting as the MN and another gNB acting as the SN. The master gNB is connected to the 5GC through an NG interface, the two gNBs are connected through the Xn interface, and the secondary gNB is connected to the 5GC through the NG-U interface. In addition, the NR-DC may also be used for the terminal device to access a single gNB, acting as both the MN and the SN, and to configure a master cell group (MCG) and a secondary cell group (SCG) simultaneously. Under the DC, the terminal device may access two cell groups, namely the MCG and the SCG. Under the MCG, there may be many cells, one of which is used to initiate initial access and is called as a primary cell (PCell). As the name suggests, the PCell is the most “important” cell in the MCG. The PCell under the MCG and a secondary cell (SCell) under the MCG are integrated together through carrier aggregation (CA). The primary cell in the MCG is the PCell, and the secondary cell in the MCG is the SCell. A primary secondary cell in the SCG is a PSCell, and the secondary cell in the SCG is the SCell. Because many signalings are only sent on the PCell or PSCell, for the convenience of description, a protocol defines a concept of special cell (sPCell). The PCell and PSCell are collectively referred to as sPCell.

### 5. Selective Activation of Cell Groups

In Rel-16 conditional handover (CHO) and in Rel-17 conditional PSCell change (CPC)/conditional PSCell addition (CPA), the terminal device with a CHO/CPC/CPA configuration must release the CHO/CPC/CPA configuration when completing random access to a target PCell/PSCell. If a network does not reconfigure and reinitialize the CHO/CPC/CPA, the terminal has no chance to subsequently continue to perform the CHO/CPC/CPA. This will increase a latency of handover or SCG change and increase signaling overhead, especially in a scene where a cell group (CG) is frequently changed within a frequency range (FR) 2. Therefore, the R18 mobility enhancement project has proposed selective activation of cell groups in the MR-DC, which may enable the CHO/CPC/CPA still to be executed subsequently after CG change, with no need for the network to reconfigure or re-initialize the CHO/CPC/CPA. This can reduce the signaling overhead and an interruption duration of the CG change.

In the selective activation of cell groups, the network device may provide a preconfigured target candidate cell group or target candidate cell to the terminal device. The terminal device may activate or deactivate the pre-configured candidate cell group or cell according to a configuration (e.g., an activation message) sent by the network device or a corresponding activation event, having no need to provide the configuration of the cell group again. In other words, during the selective activation of cell groups, after activating a new cell or cell group, or applying a new cell configuration or cell group configuration, or accessing a new cell or cell group, the terminal device will not delete the corresponding configuration information for selective activation of cell groups.

The selective activation of cell groups may also be referred to as cell group activation, which may ensure that the corresponding configuration information may still be executed after cell group or cell change, with no need for the network to reconfigure or reinitialize the corresponding configuration information for cell group activation. This may reduce the signaling overhead and the interruption duration of cell group change. The configuration information of the cell group activation may include: a configuration identity (ID) and a target cell configuration or a target cell group configuration. Optionally, the configuration information for the cell group activation may also include a trigger condition (also referred to as an execution condition or an activation condition).

In an embodiment of the disclosure, the cell group activation is a mobility management process, which includes any mobility management process in which the terminal device, by configuring the configuration of the cell group activation, activates or deactivates a corresponding cell or cell group, or applies the corresponding cell configuration or cell group configuration, or accesses the cell or cell group, according to a signaling sent by the network, a criteria specified in a protocol or in an autonomous manner.

In an embodiment of the disclosure, the cell group activation is a mobility management process, which includes any mobility management process that does not delete or release part or all of the corresponding configuration information after a mobility process. Not deleting or releasing part or all of the corresponding configuration information may also referred to as reserving part or all of the corresponding configuration information.

In the disclosure, the cell group is one or more of the MCG and the SCG. The MCG includes one or more of the PCell and the SCell. The SCG includes one or more of the PSCell and the SCell.

In the disclosure, the selective activation of cell group may include selective activation of cells or cell activation, for example, one or more of PCell activation, PSCell activation, and SCell activation.

It should be noted that in the disclosure, the method provided in any embodiment may be executed alone, or in combination with possible implementations in other embodiments, or in combination with any technical solution in the related arts.

In order to better understand a failure processing method disclosed by an embodiment of the disclosure, a communication system to which embodiments of the disclosure apply will be described below.

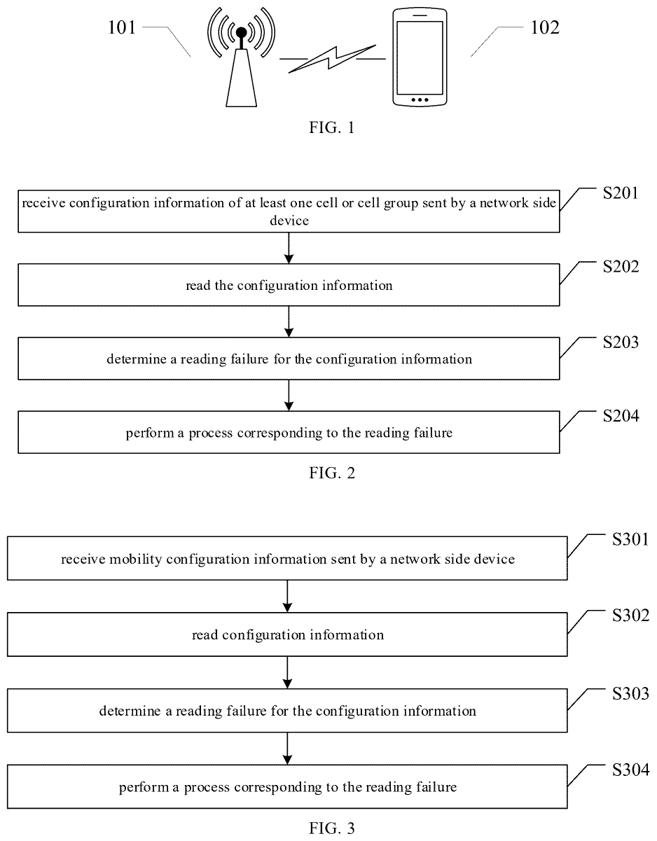

As illustrated in FIG. 1, FIG. 1 is a schematic diagram illustrating a communication system according to an embodiment of the disclosure. The communication system may include, but is not limited to, a network side device and a terminal device. The number and form of devices illustrated in FIG. 1 are only for examples and do not constitute a limitation on the embodiments of the disclosure. In practical applications, there may be two or more network side devices and two or more terminal devices. The communication system illustrated in FIG. 1 may include, for example, one network side device 101 and one terminal device 102.

It is noteworthy that the technical solutions of embodiments of the disclosure may be applied to various communication systems, such as, a long term evolution (LTE) system, a 5th generation (5G) mobile communication system, an NR system, or other future new mobile communication systems.

The network side device 101 in an embodiment of the disclosure is an entity on a network side for transmitting or receiving signals. For example, the network side device 101 may be an evolved NodeB (eNB), a transmission reception point (TRP), a next generation NodeB (gNB) in a NR system, a base station in other future mobile communication systems, or an access node in a wireless fidelity (WiFi) system. The specific technology and specific device form adopted by the network side device are not limited in an embodiment of the disclosure. The network side device provided by an embodiment of the disclosure may be composed of a central unit (CU) and a distributed unit (DU). The CU may also be referred to as a control unit. The use of CU-DU structure allows to divide a protocol layer of the network side device, such as a base station, such that some of the protocol layer functions are placed in the CU for centralized control, and some or all of the remaining protocol layer functions are distributed in the DU, and the DU is centrally controlled by the CU.

The terminal device 102 in an embodiment of the disclosure is an entity on a user side for receiving or transmitting signals, such as a cellular phone. The terminal device may also be referred to as a terminal, a user equipment (UE), a mobile station (MS), a mobile terminal (MT), and the like. The terminal device may be a car, a smart car, a mobile phone, a wearable device, a Pad with communication functions, a computer, a virtual reality (VR) terminal device, an augmented reality (AR) terminal device with wireless transceiver functions, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form adopted by the terminal device are not limited in an embodiment of the disclosure.

It is understandable that the communication system described in an embodiment of the disclosure is intended to clearly illustrate the technical solutions of embodiments of the disclosure, and does not constitute a limitation on the technical solutions provided by embodiments of the disclosure. It is understandable by those skilled in the art that as system architectures evolve and new service scenarios emerge, the technical solutions provided by embodiments of the disclosure are also applicable to similar technical problems.

A failure processing method and a failure processing apparatus provided in embodiments of the present disclosure will be introduced in detail below with reference to the accompanying drawings.

As illustrated in FIG. 2, FIG. 2 is a flowchart of a failure processing method provided by an embodiment of the disclosure. The method is executed by a terminal device. As illustrated in FIG. 2, the method may include, but is not limited to, following steps.

At step S201, configuration information of at least one cell or cell group sent by a network side device is received.

As an example, the terminal device receives the configuration information of the at least one cell sent by the network side device.

As another example, the terminal device receives the configuration information of the at least one cell group sent by the network side device. It can be seen from the above that the configuration information of cell or cell group refers to the configuration information of the cell or the configuration information of the cell group. The specific meanings of other similar descriptions in an embodiment of the disclosure are the same as the above description, which will not be repeated here.

At step S202, the configuration information is read.

For example, the terminal device reads a parameter or a field in the configuration information.

At step S203, a reading failure for the configuration information is determined.

In an embodiment of the disclosure, the reading failure for the configuration information may refer to one or more of a situation that the terminal device cannot comply with part of the configuration included in the configuration information, or a situation that the terminal device cannot comply with all the configurations included in the configuration information, or a situation that the terminal device cannot obtain part of the contents of the configuration information, or a situation that the terminal device cannot obtain all the contents of the configuration information, or a situation that the terminal device cannot read part of the parameters or fields in the configuration information, or a situation that the terminal device cannot read all the parameters or fields in the configuration information. The embodiment of the disclosure does not limit the specific definition and description of the reading failure for the configuration information.

For example, the terminal device determines the reading failure for the configuration information, and executes the process corresponding to the reading failure.

At step S204, a process corresponding to the reading failure is executed.

In an embodiment of the disclosure, the specific implementation of the terminal device executing the process corresponding to the reading failure can be referred to any other embodiment of the disclosure, which is not repeated in the disclosure.

By implementing the embodiment of the disclosure, the terminal device may execute the process corresponding to the reading failure when determining the reading failure for the configuration information. In this way, the failure in selective activation of cells or cell groups may be avoided, communication reliability may be improved.

In an implementation of an embodiment of the disclosure, mobility configuration information may include the configuration information of the at least one cell or cell group. As an example, referring to FIG. 3, FIG. 3 is a flowchart of another failure processing method provided by an embodiment of the disclosure. The method is executed by a terminal device. As illustrated in FIG. 3, the method may include, but is not limited to, following steps.

At step S301, mobility configuration information sent by a network side device is received.

In an embodiment of the disclosure, the mobility configuration information includes the configuration information of the at least one cell or cell group.

For example, the terminal device receives the mobility configuration information sent by the network side device, which includes the configuration information of the at least one cell or cell group.

In an embodiment of the disclosure, the mobility configuration information may be a radio resource control (RRC) reconfiguration message. A transmitter of the mobility configuration information may be an MCG (or an MN) or an SCG (or an SN). A sending manner of the mobility configuration information may be sent through a signaling radio bearer (SRB) 1, an SRB2 or an SRB3. For example, the mobility configuration information sent by the SCG (or SN) may be sent through a split SRB1, a split SRB2 or the SRB3.

In an optional implementation, the mobility configuration information includes a mobility configuration parameter corresponding to the at least one cell or cell group, the mobility configuration parameter of each cell or cell group includes configuration information of the corresponding cell or cell group.

For example, the terminal device receives the mobility configuration information sent by the network side device. The mobility configuration information includes the mobility configuration parameter corresponding to the at least one cell or cell group, the mobility configuration parameter includes the configuration information of the corresponding cell or cell group. When the mobility configuration information includes mobility configuration parameters corresponding to multiple cells or cell groups, the mobility configuration parameter of each cell or cell group includes the configuration information of the cell or cell group.

It should be noted that the mobility configuration information may include the mobility configuration parameters corresponding to multiple cells or cell groups, and the mobility configuration parameter corresponding to each cell or cell group corresponds to the configuration information of one cell or cell group. That is, the mobility configuration information may include configuration information corresponding to multiple cells or cell groups, so that the terminal device that receives the mobility configuration information can perform selective activation of cells or cell groups based on the mobility configuration information.

It should be noted that in an embodiment of the disclosure, the mobility configuration information includes a mobility configuration parameter corresponding to at least one cell or cell group. When the mobility configuration parameter of each cell or cell group includes the corresponding configuration information of the cell or cell group, the terminal device can receive the mobility configuration information sent by the network side device, and directly perform selective activation of cells or cell groups according to the configuration information of the cell or cell group in the mobility configuration information, Alternatively, the terminal device may receive the mobility configuration information sent by the network side device, and update the mobility configuration information stored in the terminal device according to the mobility configuration information.

At step S302, configuration information is read.

In an implementation, reading the configuration information includes: reading contents of the configuration information of the cell or cell group included in the configuration information.

For example, the terminal device reads the configuration information sent by the network side device to obtain the contents of the configuration information of the at least one cell or cell group included in the configuration information.

At step S303, a reading failure for the configuration information is determined.

In an optional implementation, determining the reading failure for the configuration information includes: determining a reading failure for the contents of the configuration information of the cell or cell group.

For example, the terminal device determines the reading failure for the configuration information in response to determining that the terminal device fails to read the contents of the configuration information of cell or cell group.

In an embodiment of the disclosure, the reading failure for the configuration information of the cell or cell group may refer to one or more a situation that the terminal device cannot comply with part of the configuration included in the configuration information of the cell or cell group, or a situation that the terminal device cannot comply with all the configurations included in the configuration information of the cell or cell group, or the terminal device cannot obtain part of the contents of the configuration information of the cell or cell group, or the terminal device cannot obtain all the contents of the configuration information of the cell or cell group, or the terminal device cannot read part of the parameters or fields in the configuration information of the cell or cell group, or the terminal device cannot read all the parameters or fields in the configuration information of the cell or cell group. The embodiment of the disclosure does not limit the specific definition and description of the reading failure for the configuration information of the cell or cell group.

At step S304, a process corresponding to the reading failure is performed.

In an implementation of an embodiment of the disclosure, performing the process corresponding to the reading failure includes at least one of: ignoring configuration information of a first cell or cell group configured by the network side device, in which the first cell or cell group includes one or more cells or cell groups for which the terminal device fails to read corresponding configuration information; continuing to use configuration information having been stored in the terminal device; sending indication information to the network side device, in which the indication information is used to inform the network side device that the terminal device fails to read configuration information or fails to reconfigure; entering an idle state; starting a RRC reconstruction process; or releasing an SCG.

For example, in response to determining the reading failure for the configuration information, the terminal device, according to actual conditions, performs at least one of: ignoring the configuration information of the first cell or cell group configured by the network side device, in which the first cell or cell group includes one or more cells or cell groups for which the terminal device fails to read corresponding the configuration information; continuing to use the configuration information having been stored in the terminal device; sending the indication information to the network side device, in which the indication information is used to inform the network side device that the terminal device fails to read the configuration information or fails to reconfigure; entering the idle state; starting the RRC reconstruction process; or releasing the SCG.

It should be noted that in an implementation of an embodiment of the disclosure, a specific process that is to be executed after the terminal device fails to read the configuration information may be specified by a protocol, or a specific process that is to be executed after the terminal device fails to read the configuration information may be pre-instructed by the network side device, or a specific process that is to be executed after the terminal device fails to read the configuration information may be determined by the terminal device itself according to a preset judgment criteria.

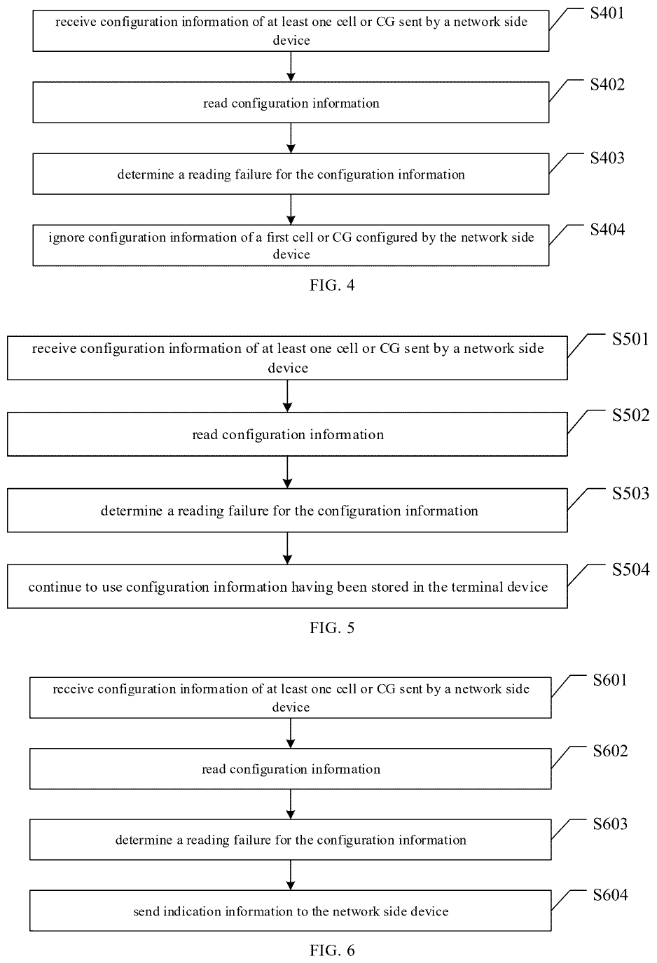

In an implementation of an embodiment of the disclosure, the terminal device may ignore the configuration information in response to determining the reading failure for the configuration information. As an example, referring to FIG. 4, FIG. 4 is a flowchart of another failure processing method provided by an embodiment of the disclosure. The method is executed by a terminal device. As illustrated in FIG. 4, the method may include, but is not limited to, following steps.

At step S401, configuration information of at least one cell or cell group sent by a network side device is received.

In an embodiment of the disclosure, step S401 may be implemented in any manner in respective embodiments of the disclosure, which is not limited in an embodiment of the disclosure and will not be repeated herein.

At step S402, configuration information is read.

In an embodiment of the disclosure, step S402 may be implemented in any manner in respective embodiments of the disclosure, which is not limited in an embodiment of the disclosure and will not be repeated herein.

At step S403, a reading failure for the configuration information is determined.

In an embodiment of the disclosure, step S403 may be implemented in any manner in respective embodiments of the disclosure, which is not limited in an embodiment of the disclosure and will not be repeated herein.

At step S404, configuration information of a first cell or cell group configured by the network side device is ignored.

For example, the terminal device ignores the contents that cannot be complied with in the configuration information of the first cell or cell group configured by the network side device.

In an optional implementation, ignoring the configuration information of the first cell or cell group configured by the network side device includes at least one of: ignoring a mobility configuration parameter corresponding to the first cell or cell group, deleting a mobility configuration parameter corresponding to the first cell or cell group stored in the terminal device, or prohibiting the terminal device from triggering access to the first cell or cell group according to the mobility configuration parameter corresponding to the first cell or cell group.

In an embodiment of the disclosure, deleting the mobility configuration parameter corresponding to the first cell or cell group stored in the terminal device may be implemented in various specific ways according to the specific situation.

For example, the mobility configuration information includes a trigger condition and cell group configuration information, in response to a failure to read the cell group configuration information, the terminal device may delete the corresponding trigger condition stored in the terminal device.

For another example, the mobility configuration information includes the trigger condition and the cell group configuration information, in response to a failure to read the cell group configuration information, the terminal device may delete only the cell group configuration information stored in the terminal device.

By implementing an embodiment of the disclosure, the terminal device may ignore the configuration information after confirming the reading failure for the configuration information. In this way, the failure in selective activation of cells or cell groups may be avoided, and communication reliability may be improved.

In an implementation of an embodiment of the disclosure, the terminal device may continue to use the configuration information having been stored in the terminal device after the reading failure of the configuration information. As an example, referring to FIG. 5, FIG. 5 is a flowchart of another failure processing method provided by an embodiment of the disclosure. The method is executed by a terminal device. As illustrated in FIG. 5, the method may include, but is not limited to, following steps.

At step S501, configuration information of at least one cell or cell group sent by a network side device is received.

In an embodiment of the disclosure, step S501 may be implemented in any manner in respective embodiments of the disclosure, which is not limited in an embodiment of the disclosure and will not be repeated herein.

At step S502, configuration information is read.

In an embodiment of the disclosure, step S502 may be implemented in any manner in respective embodiments of the disclosure, which is not limited in an embodiment of the disclosure and will not be repeated herein.

At step S503, a reading failure for the configuration information is determined.

In an embodiment of the disclosure, step S503 may be implemented in any manner in respective embodiments of the disclosure, which is not limited in an embodiment of the disclosure and will not be repeated herein.

At step S504, configuration information having been stored in the terminal device is continued to use.

For example, the terminal device continues to use the original configuration information stored in the terminal device in response to determining the read failure for the configuration information.

In an optional implementation, continuing to use the configuration information having been stored in the terminal device includes: continuing to use a mobility configuration parameter corresponding to the first cell or cell group having been stored in the terminal device; or continuing to use configuration information of the corresponding cell or cell group included in the mobility configuration parameter, and updating other configuration information included in the mobility configuration parameter.

As an example, when the terminal device continues to use the configuration information having been stored in the terminal device during performing the process corresponding to the reading failure, in response to the terminal device having been stored the mobility configuration parameter corresponding to the first cell or cell group, the terminal device continues to use the mobility configuration parameter corresponding to the first cell or cell group and does not update the configuration information corresponding to the first cell or cell group.

As another example, when the terminal device continues to use the original configuration information during performing the process corresponding to the reading failure, in response to the terminal device having been stored the mobility configuration parameter corresponding to the first cell or cell group, the terminal device continues to use the configuration information of the corresponding cell or cell group included in the mobility configuration parameter and updates other configuration information included in the mobility configuration parameter.

By implementing an embodiment of the disclosure, the terminal device may continue to use the original configuration information to perform selective activation of cells or cell groups in response to determining the read failure for the configuration information. In this way, the failure of selective activation of cells or cell groups may be avoided, and communication reliability may be improved.

In an implementation of an embodiment of the disclosure, the terminal device may send the indication information to the network side device in response to determining the reading failure for the configuration information. As an example, refer to FIG. 6, FIG. 6 is a flowchart of another failure processing method provided by an embodiment of the disclosure. The method is executed by a terminal device. As illustrated in FIG. 6, the method may include, but is not limited to, following steps.

At step S601, configuration information of at least one cell or cell group sent by a network side device is received.

In an embodiment of the disclosure, step S601 may be implemented in any manner in respective embodiments of the disclosure, which is not limited in an embodiment of the disclosure and will not be repeated herein.

At step S602, configuration information is read.

In an embodiment of the disclosure, step S602 may be implemented in any manner in respective embodiments of the disclosure, which is not limited in an embodiment of the disclosure and will not be repeated herein.

At step S603, a reading failure for the configuration information is determined.

In an embodiment of the disclosure, step S603 may be implemented in any manner in respective embodiments of the disclosure, which is not limited in an embodiment of the disclosure and will not be repeated herein.

At step S604, indication information is sent to the network side device.

For example, the terminal device sends corresponding indication information to the network side device according to different situations of the read failure for the configuration information.

In an optional implementation, the above indication information is used to inform the network side device that the terminal fails to to read the configuration information.

For example, when the terminal device sends the indication information to the network side device that sends the configuration information during performing the process corresponding to the reading failure, the indication information is used to inform the network side device that the terminal device fails to read the configuration information.

Optionally, the indication information includes at least one of: an identity of the first cell or cell group; configuration information of the first cell or cell group; a configuration information identity of the first cell or cell group; a mobility configuration parameter of the first cell or cell group; an identity of the mobility configuration parameter of the first cell or cell group; or a cause of failure.

In an embodiment of the disclosure, the above cause of failure may be a cause why the terminal device fails to read the configuration information or the cause why the terminal device fails to reconfigure.

Optionally, the indication information is used to instruct the terminal device to ignore the configuration information of the first cell or cell group, and/or, the indication information is used to indicate whether the terminal device continues to use the configuration information having been stored in the terminal device.

As an example, the above indication information is used to instruct the terminal device to ignore the configuration information of the first cell or cell group.

As another example, the above indication information is used to indicate whether the terminal device continues to use the configuration information having been stored in the terminal device.

As another example, the above indication information is used to instruct the terminal device to ignore the configuration information of the first cell or cell group, and is also used to indicate whether the terminal device continues to use the configuration information having been stored by the terminal device.

It should be noted that in an embodiment of the disclosure, the above indication information may be indicated by 1 bit of data in data sent by the terminal device to the network side device.

By implementing an embodiment of the disclosure, the terminal device can inform the network side device of relevant information of the reading failure for the configuration information by sending the indication information to the network side device, so that the network side device can perform subsequent processes based on the indication information, which may avoid occurrence of the failure in selective activation of cells or cell groups, and improve communication reliability.

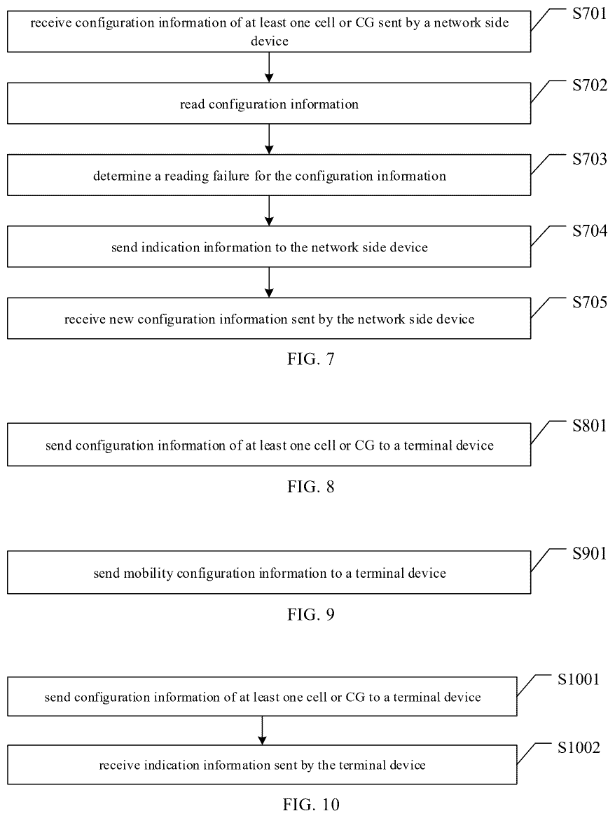

In an implementation of an embodiment of the disclosure, after sending the configuration information to the network side device, the terminal device can also receive the configuration information sent by the network side device. As an example, referring to FIG. 7, FIG. 7 is a flowchart of another failure processing method provided by an embodiment of the disclosure. The method is executed by a terminal device. As illustrated in FIG. 7, the method may include, but is not limited to, following steps.

At step S701, configuration information of at least one cell or cell group sent by a network side device is received.

In an embodiment of the disclosure, step S701 may be implemented in any manner in respective embodiments of the disclosure, which is not limited in an embodiment of the disclosure and will not be repeated herein.

At step S702, configuration information is read.

In an embodiment of the disclosure, step S702 may be implemented in any manner in respective embodiments of the disclosure, which is not limited in an embodiment of the disclosure and will not be repeated herein.

At step S703, a reading failure for the configuration information is determined.

In an embodiment of the disclosure, step S703 may be implemented in any manner in respective embodiments of the disclosure, which is not limited in an embodiment of the disclosure and will not be repeated herein.

At step S704, indication information is sent to the network side device.

In an embodiment of the disclosure, step S704 may be implemented in any manner in respective embodiments of the disclosure, which is not limited in an embodiment of the disclosure and will not be repeated herein.

At step S705, configuration information sent by the network side device is received.

In an embodiment of the disclosure, the above configuration information is reconfigured by the network side device according to the indication information sent by the terminal device.

For example, the terminal device receives the configuration information sent by the network side device, and the configuration information is reconfigured by the network side device according to the indication information sent by the terminal device.

By implementing an embodiment of the disclosure, the terminal device may send the indication information in response determining the read failure for the configuration information, and then receive the configuration information sent by the network side device, so that the terminal device can perform selective activation of cells or cell groups based on the configuration information. Therefore, the failure of selective activation of cells or cell groups may be avoided, and communication reliability may be improved.

In an implementation of an embodiment of the disclosure, the terminal device may determine the configuration information having been stored in the terminal device before receiving a reconfiguration message sent by the network side device.

As an example, in response to determining the read failure for the configuration information, the terminal device determines the configuration information having been stored in the terminal device when performing an operation of ignoring the configuration information of one or more cells or cell groups corresponding to the configuration information of the reading failure before receiving the reconfiguration message sent by the network side device.

As another example, in response to determining the read failure for the configuration information, the terminal device determines the configuration information having been stored in the terminal device when performing an operation of continuing to use the original configuration information before receiving the reconfiguration message sent by the network side device.

By implementing an embodiment of the disclosure, the terminal device may determine whether the configuration information having been stored in the terminal device is valid before receiving the reconfiguration message from the network side, so that the terminal device can determine whether the subsequent steps can be executed based on the configuration information that has been stored. In this way, the failure of selective activation of cells or cell groups may be avoided, and communication reliability may be improved.

In an implementation of an embodiment of the disclosure, in response to determining that the contents of the configuration information are successfully read, the terminal device may store the read contents to a preset variable, or update the contents stored in a first variable according to the read contents.

In an embodiment of the disclosure, the preset variable may be a Var variable.

As an example, in response to successfully reading the contents of the configuration information, the terminal device stores the read contents into the Var variable.

As another example, in response to successfully reading the contents of the configuration information, the terminal device updates the corresponding contents stored in the first variable based on the read contents.

It is understood that the above embodiments are implementations of the failure processing method of embodiments of the disclosure described from the perspective of the terminal device. Embodiments of the disclosure also provide another failure processing method, and implementations of this failure processing method will be described below from the perspective of the network side device.

Referring to FIG. 8, FIG. 8 is a flowchart of another failure processing method provided by an embodiment of the disclosure. The method is executed by a network side device. As illustrated in FIG. 8, the method may include, but is not limited to, following steps.

At step S801, configuration information of at least one cell or cell group is sent to a terminal device.

In an implementation, the configuration information of the at least one cell or cell group may be included in mobility configuration information.

For example, the network side device sends the mobility configuration information to the terminal device. The mobility configuration information includes the configuration information of the at least one cell or cell group.

By implementing an embodiment of the disclosure, the network side device sends the configuration information of the at least one cell or cell group to the terminal device, so that the terminal device may perform selective activation of cells based on the configuration information, thereby improving communication reliability.

In an implementation of an embodiment of the disclosure, a mobility configuration parameter corresponding to the at least one cell or cell group may also be included in the mobility configuration information. As an example, referring to FIG. 9, FIG. 9 is a flowchart of another failure processing method provided by an embodiment of the disclosure. The method is performed by a network side device. As illustrated in FIG. 9, the method may include, but is not limited to, following steps.

At step S901, mobility configuration information is sent to a terminal device.

In an optional implementation, the mobility configuration information includes a mobility configuration parameter corresponding to the at least one cell or cell group, and the mobility configuration parameter of each cell or cell group includes configuration information of the corresponding cell or cell group.

For example, the network side device sends the mobility configuration information to the terminal device. The mobility configuration information includes the mobility configuration parameter corresponding to the at least one cell or cell group, and the mobility configuration parameter of each cell or cell group includes the configuration information of the cell or cell group. When the mobility configuration information includes mobility configuration parameters corresponding to multiple cells or cell groups, the configuration information of each cell or cell group is included in the mobility configuration parameter corresponding to the cell or cell group.

It should be noted that in the embodiment of the disclosure, in a case that the mobility configuration information includes the mobility configuration parameters corresponding to multiple cells or cell groups, the network side device sends the mobility configuration parameters to the terminal device, so that the terminal device may read the mobility configuration parameter corresponding to any one of the cells or cell groups from the mobility configuration parameters, and perform selective activation of cells or cell groups according to the configuration information of the cell or cell group in the mobility configuration parameter corresponding to the cell or cell group. Alternatively, the network side device may send the mobility configuration information to the terminal device, so that the terminal device may update its own stored mobility configuration information according to the mobility configuration information.

By implementing an embodiment of the disclosure, the network side device may send the mobility configuration information to the terminal device, so that the terminal device can perform selective activation of cells based on the configuration information, thereby improving the communication reliability.

In an implementation of an embodiment of the disclosure, the network side device can also receive indication information sent by the terminal device. As an example, referring to FIG. 10, FIG. 10 is a flowchart of another failure processing method provided by an embodiment of the disclosure. The method is performed by a network side device. As illustrated in FIG. 10, the method may include, but is not limited to, following steps.

At step S1001, configuration information of at least one cell or cell group is sent to a terminal device.

In an embodiment of the disclosure, step S1001 may be implemented in any manner in respective embodiments of the disclosure, which is not limited in an embodiment of the disclosure and will not be repeated herein.

At step S1002, indication information sent by the terminal device is received.

In an embodiment of the disclosure, the indication information is used to inform the network side device that the terminal device fails to read the configuration information or fails to reconfigure.

As an example, the network side device receives the indication information sent by the terminal device, and the indication information is used to inform the network side device that the terminal device fails to read the configuration information.

As an example, the network side device receives the indication information sent by the terminal device, and the indication information is used to inform the network side device that the terminal device fails to reconfigure.

In an optional implementation, the above indication information is used to inform the network side device that the terminal device fails to read the configuration information or fails to reconfigure.

As an example, the above indication information is used to inform the network side device that the terminal device fails to read the configuration information.

As another example, the above indication information is used to inform the network side device that the terminal device fails to reconfigure.

Optionally, the indication information includes at least one of: an identity of the first cell or cell group; configuration information of the first cell or cell group; a configuration information identity of the first cell or cell group; a mobility configuration parameter of the first cell or cell group; an identity of the mobility configuration parameter of the first cell or cell group; or a cause of failure.

In an embodiment of the disclosure, the above cause of failure may be a cause why the terminal device fails to read the configuration information or a cause why the terminal device fails to reconfigure.

Optionally, the indication information is used to instruct the terminal device to ignore the configuration information of the first cell or cell group, and/or, the indication information is used to indicate whether the terminal device continues to use the configuration information having been stored in the terminal device.

As an example, the above indication information is used to instruct the terminal device to ignore the configuration information of the first cell or cell group.

As another example, the above indication information is used to indicate whether the terminal device continues to use the configuration information having been stored in the terminal device.

As another example, the above indication information is used to instruct the terminal device to ignore the configuration information of the first cell or cell group, and is also used to indicate whether the terminal device continues to use the configuration information having been stored in the terminal device.

For example, the network side device receives the indication information sent by the terminal device, and the indication information is used to inform the network side device that the terminal device fails to read the configuration information of the at least one cell or cell group.

By implementing an embodiment of the disclosure, the network side device may receive the indication information sent by the terminal device, so that the network side device can learn of whether the terminal device fails to read the configuration information or fails to reconfigure and perform following operations based on the indication information. In this way, the failure of selective activation of cells or cell groups may be avoided, and communication reliability may be improved.

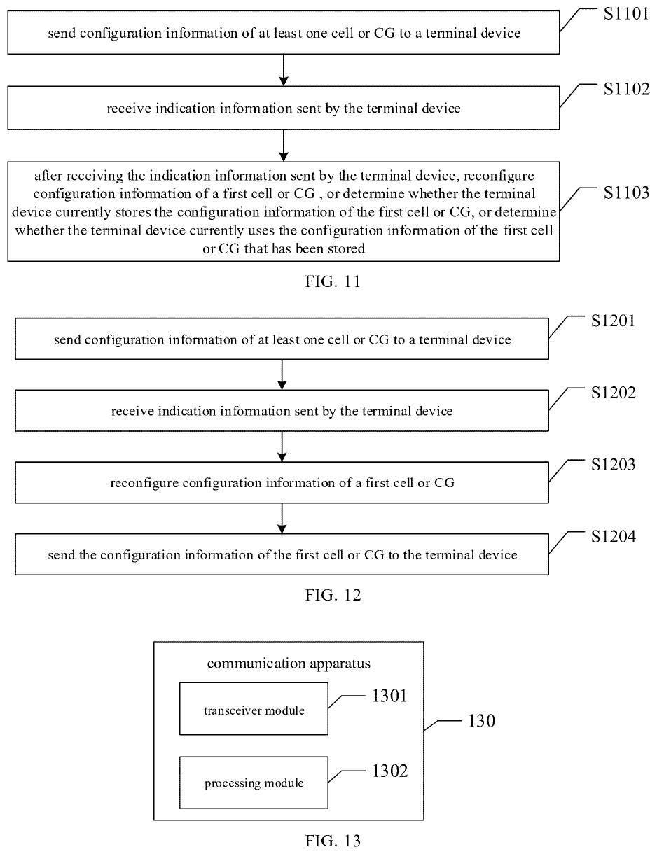

In an implementation of an embodiment of the disclosure, the network side device performs different subsequence processes based on the received indication information sent by the terminal device. As an example, referring to FIG. 11, FIG. 11 is a flowchart of another failure processing method provided by an embodiment of the disclosure. The method is performed by a network side device. As illustrated in FIG. 11, the method may include, but is not limited to, following steps.

At step S1101, configuration information of at least one cell or cell group is sent to a terminal device.

In an embodiment of the disclosure, step S1101 may be implemented in any manner in respective embodiments of the disclosure, which is not limited in an embodiment of the disclosure and will not be repeated herein.

At step S1102, indication information sent by the terminal device is received.

In an embodiment of the disclosure, step S1102 may be implemented in any manner in respective embodiments of the disclosure, which is not limited in an embodiment of the disclosure and will not be repeated herein.

At step S1103, after receiving the indication information sent by the terminal device, configuration information of a first cell or cell group is reconfigured, or it is determined whether the terminal device currently stores the configuration information of the first cell or cell group, or it is determined whether the terminal device currently uses the configuration information of the first cell or cell group that has been stored.

The first cell or cell group includes one or more cells or cell groups for which the terminal device fails to read corresponding configuration information.

As an example, the network side device reconfigures the configuration information of the first cell or cell group after receiving the indication information sent by the terminal device.

As another example, the network side device determines whether the terminal device currently stores the configuration information of the first cell or cell group after receiving the indication information sent by the terminal device.

As another example, after receiving the indication information sent by the terminal device, the network side device determines whether the terminal device uses the original configuration information of the first cell or cell group having been stored in the terminal device.

By implementing an embodiment of the disclosure, after receiving the indication information sent by the terminal device, the network side device may learn of whether the terminal device fails to read the configuration information or fails to reconfigure and perform following operations based on the indication information. In this way, occurrence of the failure of selective activation of cells or cell groups may be avoided, and communication reliability may be improved. In an implementation of an embodiment of the disclosure, the network side device reconfigures the configuration information of the first cell or cell group after receiving the indication information sent by the terminal device, and sends the reconfigured configuration information to the terminal device. As an example, referring to FIG. 12, FIG. 12 is a flowchart of another failure processing method provided by an embodiment of the disclosure. The method is performed by a network side device. As illustrated in FIG. 12, the method may include, but is not limited to, following steps.

At step S1201, configuration information of at least one cell or cell group is sent to a terminal device.

In an embodiment of the disclosure, step S1201 may be implemented in any manner in respective embodiments of the disclosure, which is not limited in an embodiment of the disclosure and will not be repeated herein.

At step S1202, indication information sent by the terminal device is received.

In an embodiment of the disclosure, step S1202 may be implemented in any manner in respective embodiments of the disclosure, which is not limited in an embodiment of the disclosure and will not be repeated herein.

At step S1203, configuration information of a first cell or cell group is reconfigured.

In an embodiment of the disclosure, step S1203 may be implemented in any manner in respective embodiments of the disclosure, which is not limited in an embodiment of the disclosure and will not be repeated herein.

At step S1204, the configuration information is sent to the terminal device.

In an embodiment of the disclosure, the configuration information is reconfigured by the network side device according to the indication information sent by the terminal device.

For example, the network side device sends the reconfigured configuration information to the terminal device. The configuration information is reconfigured by the network side device according to the received indication information sent by the terminal device.

By implementing an embodiment of the disclosure, after receiving the indication information sent by the terminal device, the network side device reconfigures the configuration information of the first cell or cell group, and sends the reconfigured configuration information to the terminal device, so that the terminal device may perform following operations based on the configuration information. In this way, occurrence of the failure of selective activation of cells or cell groups may be avoided, and communication reliability may be improved.

In the above-mentioned embodiments provided by the disclosure, the methods provided by the embodiments of the disclosure are introduced from the perspectives of the terminal device and the network side device respectively. It can be seen from the above-mentioned embodiments of the disclosure that in the failure processing method provided by the disclosure, after determining that the reading of the configuration information of cell group included in the mobility configuration information sent by the network side device has failed, the terminal device can execute any one or more of a plurality of processes corresponding to the reading failure based on its own situation, so as to avoid the influence of the reading failure on the subsequent mobility operations. The processes corresponding to the reading failure includes: continuing to use the original configuration information that has been stored, or sending indication information for indicating the reading failure to the network side device that sends the mobility configuration information to request the network side device to reconfigure the mobility configuration information.

It should be noted that the mobility configuration information includes configuration information for selective activation of cells or cell groups, and the configuration information of cells or cell groups is configuration information of corresponding “cells or cell groups to be activated” (for example, an RRC reconfiguration message).

In detail, the terminal device receives the mobility configuration information sent by the network side device and reads configuration information of cell groups included in the configuration information. In response to the terminal device successfully reading the configuration information of cell groups included in the configuration information, the terminal device updates the mobility configuration information already stored by itself based on the read configuration information (for example, stores new mobility configuration information in a Var variable). In response to the terminal device failing to read the configuration information, the terminal device executes at least one of the following processes corresponding to the reading failure:
1) ignoring configuration information of corresponding cells or cell groups configured by the network side device;

The above cells or cell groups include one or more cells or cell groups for which the terminal device fails to read the corresponding configuration information.

In an optional implementation, the terminal device may ignore the corresponding mobility configuration information of the cells or cell groups for which the terminal device fails to read corresponding configuration information of cell groups.

In an optional implementation, the terminal device may delete the stored mobility configuration information corresponding to the cell groups for which the terminal device fails to read corresponding configuration information of cell groups.

For example, the mobility configuration information includes a trigger condition, an ID and configuration information of cell groups, in response to failing to read the configuration information of cells or cell groups, the terminal device deletes the corresponding trigger condition, ID, etc. stored in the terminal device.

For example, the mobility configuration information includes the trigger condition, the ID and the configuration information of cell groups, in response to failing to read the configuration information of cells or cell groups, the terminal device deletes only the configuration information of cells or cell groups.

Optionally, other terminal devices cannot trigger access to this cell or cell group according to the mobility configuration information of this cell or cell group.
2) continuing to use original configuration information;

In an optional implementation, assuming that the terminal device has already been stored the mobility configuration information corresponding to the cell or cell group for which the terminal device fails to read the corresponding configuration information, the terminal device may continue to use the mobility configuration information that has been stored.

In an optional implementation, in response to the terminal device having already been stored the mobility configuration information corresponding to the cell or cell group for which the terminal device fails to read the configuration information, the terminal device can continue to use the configuration information in the original mobility configuration information corresponding to this cell or cell group, without updating the configuration information of the cell or cell group in the mobility configuration information corresponding to this cell or cell group, but update other configuration information.

It should be noted that in response to the terminal device having already stored the mobility configuration information corresponding to this cell group, but the mobility configuration information sent by the network side device also including corresponding mobility configuration information of this cell, the terminal device updates the mobility configuration information of this cell group, and if the terminal device fails to read the configuration information, the update is failed.
3) sending indication information to the network side device;

For example, the terminal device sends the indication information to the network side device that sends the mobility configuration information, to inform the network side device that the terminal device fails to read the configuration information of a certain cell group or failed to reconfigure. The indication information includes an identity of the cell or cell group for which the terminal fails to read the configuration information, an identity of the corresponding mobility configuration information, an identity of the configuration information of the corresponding cell or cell group, and a cause (or type) of reading failure.

In an optional implementation, the indication information may be a single 1-bit indication.

In an optional implementation, assuming that the terminal device ignores the configuration information of the first cell or cell group configured by the network side device, the indication information may also instruct the terminal device to ignore the mobility configuration information of this cell group.

Optionally, the indication information may carry a cause why the terminal device ignores the configuration information of the first cell or cell group configured by the network side device, the cause may be reading failure or reconfiguration failure.

Optionally, the indication information may also include an identity of the cell or cell group for which the terminal device fails to read the configuration information, an identity of the corresponding mobility configuration information, and an identity of configuration information of the corresponding cell or cell group.

In an optional implementation, the indication information indicates whether the terminal device continues to use the original configuration.

Optionally, the indication information may also indicate that the terminal device uses the original mobility configuration, or the original configuration of the cell or cell group.

In an optional implementation, the indication information may also include an identity of a cell group, an identity of the corresponding mobility configuration information, and an identity of the configuration information of the corresponding cell group.

Optionally, the indication information may also be the cause why the terminal device sends the indication information, and the cause may be reading failure or reconfiguration failure.
4) entering an idle state;
5) starting a reconstruction process; and
6) releasing a SCG.

From the above, in response to determining to the read failure or the configuration information, the terminal device may execute the process corresponding to the reading failure. In this way, the failure of selective activation of cells or cell groups may be avoided, and communication reliability may be improved.

For the network side device, in response to the terminal device failing to read the configuration information, and executing the above operation of sending the indication information to the network side device, the network side device, may, after receiving the indication information, reconfigure the configuration of the corresponding cell or cell group for which the terminal device fails to read the configuration information, and send the reconfigured new configuration information to the terminal device. Alternatively, the network side device may determine whether the terminal device currently stores the mobility configuration information corresponding to this cell group, or the network side device may determine whether the termianl currently uses the original configuration information of this cell or cell group. Therefore, after receiving the indication information sent by the terminal device, the network side device may reconfigure the configuration information of the cell or cell group, and send the reconfigured configuration information to the terminal device, so that the terminal device may perform subsequent operations based on the above configuration information. In this way, occurrence of the failure of selective activation of cells or cell groups may be avoided, and communication reliability may be improved.

It should be noted that in an embodiment of the disclosure, the configuration information of the cell or cell group is the configuration information described above.

In the above embodiments of the disclosure, the methods according to the embodiments of the disclosure are described from the perspectives of the network side device and the terminal device, respectively. In order to realize each of the functions in the methods according to the above embodiments of the disclosure, the network side device and the terminal device may include a hardware structure, a software module, and realize each of the above functions in the form of hardware structure, software module, or a combination of hardware structure and software module. A certain function of the above functions may be performed in the form of hardware structure, software module, or a combination of hardware structure and software module. As illustrated in FIG. 13, FIG. 13 is a schematic diagram illustrating a communication apparatus 130 according to an embodiment of the disclosure. The communication apparatus 130 illustrated in FIG. 13 may include a transceiver module 1301 and a processing module 1302. The transceiver module 1301 may include a transmitting module and/or a receiving module. The transmitting module is configured to perform a transmitting function, and the receiving module is configured to perform a receiving function, so that the transceiver module 1301 can perform the transmitting function and/or the receiving function.

The communication apparatus 130 may be a terminal device, a device in the terminal device, or a device that can be used together with the terminal device. Alternatively, the communication apparatus 130 may be a network side device, a device in the network side device, or a device that can be used together with the network side device.

In a case that the communication apparatus 130 is the terminal device, the transceiver module 1301 is configured to receive configuration information of at least one cell or cell group sent by a network side device, and the processing module 1302 is configured to read the configuration information, determine a reading failure for the configuration information, and perform a process corresponding to the reading failure.

In an implementation, the transceiver module 1301 is further configured to: receive mobility configuration information sent by the network side device, in which the mobility configuration information includes the configuration information of the at least one cell or cell group.

In an implementation, the mobility configuration information includes a mobility configuration parameter corresponding to the at least one cell or cell group, and the mobility configuration parameter of each cell or cell group includes configuration information of the corresponding cell or cell group.

In an implementation, the processing module 1302 is further configured to: read contents of the configuration information of the cell or cell group included in the configuration information.

In an optional implementation, the processing module 1302 is further configured to: determine a reading failure for the contents of the configuration information of the cell or cell group.

In an optional implementation, the processing module is configured to perform at least one of: ignoring configuration information of a first cell or cell group configured by the network side device, in which the first cell or cell group includes one or more cells or cell groups for which the terminal device fails to read corresponding configuration information; continuing to use configuration information having been stored in the terminal device; sending indication information to the network side device, in which the indication information is used to inform the network side device that the terminal device fails to read the configuration information or fails to reconfigure; entering an idle state; starting a RRC reconstruction process; and releasing a SCG.

Optionally, the processing module 1302 is further configured to perform at least one of: ignoring a mobility configuration parameter corresponding to the first cell or cell group; deleting the mobility configuration parameter corresponding to the first cell or cell group stored in the terminal device; or prohibiting the terminal device from triggering access to the first cell or cell group according to the mobility configuration parameter corresponding to the first cell or cell group.

Optionally, the processing module 1302 is further configured to: continue to use a mobility configuration parameter corresponding to the first cell or cell group having been stored in the terminal device; or continue to use configuration information of the corresponding cell or cell group included in the mobility configuration parameter, and update other configuration information included in the mobility configuration parameter.

Optionally, the indication information includes at least one of: an identity of the first cell or cell group; configuration information of the first cell or cell group; a configuration information identity of the first cell or cell group; a mobility configuration parameter of the first cell or cell group; an identity of the mobility configuration parameter; or a cause of failure.

Optionally, the indication information is used to instruct the terminal device to ignore the configuration information of the first cell or cell group, and/or, the indication information is used to indicate whether the terminal device continues to use the configuration information having been stored in the terminal device.

In an implementation, the processing module 1302 is further configured to: determine the configuration information having been stored in the terminal device before receiving a reconfiguration message sent by the network side device.

In a case that the communication apparatus 130 is the network side device, and the transceiver module 1301 is configured to send configuration information of at least one cell or cell group to the terminal device.

In an implementation, the transceiver module 1302 is further configured to: send mobility configuration information to the terminal device, in which the mobility configuration information includes the configuration information of the at least one cell or cell group.

In an optional implementation, the mobility configuration information includes a mobility configuration parameter corresponding to the at least one cell or cell group, and the mobility configuration parameter of each cell or cell group includes configuration information of the corresponding cell or cell group.

In an implementation, the transceiver module 1301 is further configured to: receive indication information sent by the terminal device, in which the indication information is used to inform the network side device that the terminal device fails to read the configuration information or fails to reconfigure.

In an optional implementation, the apparatus further includes a processing module 1302. The processing module 1302 is configured to: reconfigure configuration information of the first cell or cell group after receiving the indication information sent by the terminal device, in which the first cell or cell group includes one or more cells or cell groups for which the terminal device fails to read the corresponding configuration information; or determine whether the terminal device currently stores the configuration information of the first cell or cell group; or, determine whether the terminal device currently uses the configuration information of the first cell or cell group that has been stored.

Optionally, the indication information includes at least one of: an identity of the first cell or cell group; configuration information of the first cell or cell group; a configuration information identity of the first cell or cell group; a mobility configuration parameter of the first cell or cell group; an identity of the mobility configuration parameter; or a cause of failure.

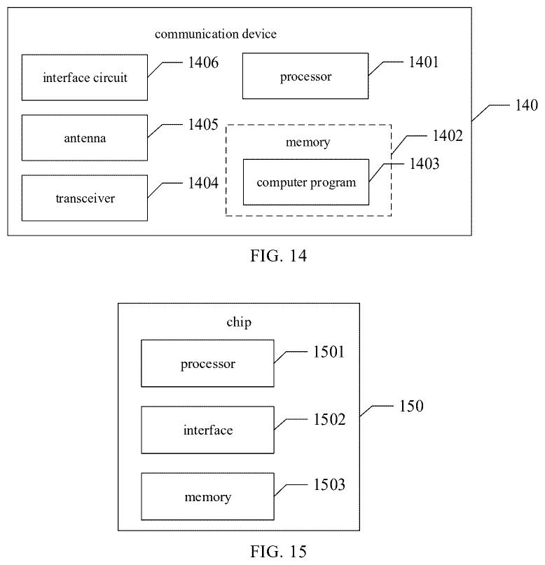

As illustrated in FIG. 14, FIG. 14 is a schematic diagram of another communication apparatus 140 provided by an embodiment of the disclosure. The communication apparatus 140 may be a network side device, a terminal device, or a chip, a chip system or a processor that supports the network side device to realize the above-described methods, or a chip, a chip system or a processor that supports the terminal device to realize the above-described methods. The device may be used to realize the methods described in the above method embodiments with reference to the description of the above-described method embodiments.

The communication apparatus 140 may include one or more processors 1401. The processor 1401 may be a general purpose processor or a dedicated processor, such as, a baseband processor or a central processor. The baseband processor is used for processing communication protocols and communication data. The central processor is used for controlling the communication apparatus (e.g., base station, baseband chip, terminal device, terminal device chip, DU, or CU), executing computer programs, and processing data of the computer programs.

Optionally, the communication apparatus 140 may include one or more memories 1402 on which computer programs 1403 may be stored. The processor 1401 executes the computer programs 1403 to cause the communication apparatus 140 to perform the methods described in the above method embodiments. Optionally, data may also be stored in the memory 1402. The communication apparatus 140 and the memory 1402 may be set separately or integrated together.

Optionally, the communication apparatus 140 may also include a transceiver 1404 and an antenna 1405. The transceiver 1404 may be referred to as transceiver unit, transceiver machine, or transceiver circuit, for realizing the transceiver function. The transceiver 1404 may include a receiver and a transmitter. The receiver may be referred to as receiver machine or receiving circuit, for realizing the receiving function. The transmitter may be referred to as transmitter machine or transmitting circuit, for realizing the transmitting function.

Optionally, the communication apparatus 140 may also include one or more interface circuits 1406. The interface circuits 1406 are used to receive code instructions and transmit them to the processor 1401. The processor 1401 runs the code instructions to cause the communication apparatus 140 to perform the method described in the method embodiments.

In a case that the communication apparatus 140 is a terminal device, the processor 1401 is used for executing steps S202, S203 and S204 in FIG. 2, steps S302, S303 and S304 in FIG. 3, steps S402, S403 and S404 in FIG. 4, steps S502, S503 and S504 in FIG. 5, steps S602 and S603 in FIG. 6, and steps S702 and S703 in FIG. 7. The transceiver 1404 is configured to execute step S201 in FIG. 2, step 301 in FIG. 3, step S401 in FIG. 4, steps S501 and S504 in FIG. 5, steps S601 and S604 in FIG. 6, and steps S701, S704 and S705 in FIG. 7.

In a case thatthe communication apparatus 140 is a network side device, the transceiver 1404 is used to execute step S801 in FIG. 8, step S901 in FIG. 9, step S1001 and step S1002 in FIG. 10, steps S1101, S1102 and S1103 in FIG. 11, and steps S1201, S1202 and S1204 in FIG. 12. The processor 1401 is used for executing step S1103 in FIG. 11, and step S1203 in FIG. 12.

In an implementation, the processor 1401 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 1401 can store a computer program. When the processor 1401 executes the computer program, the communication apparatus 140 is caused to perform the method described in the above method embodiments. The above computer program may be solidified in the processor 1401, in such case, the processor 1401 may be implemented by hardware.

In an implementation, the communication apparatus 140 may include circuits. The circuits may implement the sending, receiving or communicating function in the preceding method embodiments. The processor and transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the above description of embodiments may be a network side device or a terminal device, but the scope of the communication apparatus described in the disclosure is not limited thereto, and the structure of the communication apparatus may not be limited by FIG. 14. The communication apparatus may be a stand-alone device or may be part of a larger device. For example, the described communication apparatus may be:
(1) a stand-alone IC, chip, chip system or subsystem;
(2) a collection of ICs including one or more ICs, optionally, the collection of ICs may also include storage components for storing data and computer programs;
(3) an ASIC, such as a modem;
(4) modules that may be embedded within other devices;
(5) receivers, terminal devices, smart terminal devices, cellular phones, wireless devices, handheld machines, mobile units, in-vehicle devices, network side devices, cloud devices, artificial intelligence devices, and the like; and
(6) others.

The case where the communication apparatus may be a chip or a chip system may be referred to the schematic diagram of a chip 150 shown in FIG. 15. In FIG. 15, the chip includes a processor 1501 and an interface 1502. There may be one or more processors 1501, and there may be multiple interfaces 1502.

For the case where the chip is used to implement the functions of the terminal device in the embodiments of the disclosure,
the interface 1502 is configured to receive configuration information of at least one cell or cell group sent by a network side device, and the processor 1501 is configured to read the configuration information, and is further configured to determine a reading failure for the configuration information, and perform a process corresponding to the reading failure.

In an implementation, the interface 1502 is configured to: receive mobility configuration information sent by the network side device, in which the mobility configuration information includes the configuration information of at least one cell or cell group.

In an implementation, the mobility configuration information includes a mobility configuration parameter corresponding to the at least one cell or cell group, and the mobility configuration parameter of each cell or cell group includes configuration information of the corresponding cell or cell group.

In an implementation, the processor 1501 is configured to: read contents of the configuration information of the cell or cell group included in the configuration information.

In an optional implementation, the processor 1501 is configured to: determine a reading failure for the contents of the configuration information of the cell or cell group.

In an optional implementation, the processor 1501 is configured to perform at least one of: ignoring configuration information of a first cell or cell group configured by the network side device, in which the first cell or cell group includes one or more cells or cell groups for which the terminal device fails to read corresponding configuration information; continuing to use configuration information having been stored in the terminal device; sending indication information to the network side device, in which the indication information is used to inform the network side device that the terminal device fails to read the configuration information or fails to reconfigure; entering an idle state; starting a RRC reconstruction process; and releasing a SCG.

Optionally, the processor 1501 is configured to perform at least one of: ignoring a mobility configuration parameter corresponding to the first cell or cell group; deleting the mobility configuration parameter corresponding to the first cell or cell group stored in the terminal device; or prohibiting the terminal device from triggering access to the first cell or cell group according to the mobility configuration parameter corresponding to the first cell or cell group.

Optionally, the processor 1501 is configured to: continue to use a mobility configuration parameter corresponding to the first cell or cell group having been stored in the terminal device; or continue to use configuration information of the corresponding cell or cell group included in the mobility configuration parameter, and update other configuration information included in the mobility configuration parameter.

Optionally, the indication information includes at least one of: an identity of the first cell or cell group; configuration information of the first cell or cell group; a configuration information identity of the first cell or cell group; a mobility configuration parameter of the first cell or cell group; an identity of the mobility configuration parameter; or a cause of failure.

Optionally, the indication information is used to instruct the terminal device to ignore the configuration information of the first cell or cell group, and/or, the indication information is used to indicate whether the terminal device continues to use the configuration information having been stored in the terminal device.

In an implementation, the processor 1501 is configured to: determine the configuration information having been stored in the terminal device before receiving a reconfiguration message sent by the network side device.

For the case where the chip is used to implement the functions of the network side device in the embodiments of the disclosure, the interface 1502 is configured to send configuration information of at least one cell or cell group to a terminal device.

In an implementation, the interface 1502 is configured to: send mobility configuration information to the terminal device, in which the mobility configuration information includes the configuration information of the at least one cell or cell group.

In an optional implementation, the mobility configuration information includes a mobility configuration parameter corresponding to the at least one cell or cell group, and the mobility configuration parameter of each cell or cell group includes configuration information of the corresponding cell or cell group.

In an implementation, the interface 1502 is configured to: receive indication information sent by the terminal device, in which the indication information is used to inform the network side device that the terminal device fails to read the configuration information or fails to reconfigure.

In an optional implementation, the apparatus further includes a processor 1501. The processor 1501 is configured to: reconfigure configuration information of a first cell or cell group, in which the first cell or cell group includes one or more cells or cell groups for which the terminal device fails to read corresponding configuration information; or determine whether the terminal device currently stores the configuration information of the first cell or cell group; or, determine whether the terminal device currently uses the configuration information of the first cell or cell group that has been stored.

Optionally, the indication information includes at least one of: an identity of the first cell or cell group; configuration information of the first cell or cell group; a configuration information identity of the first cell or cell group; a mobility configuration parameter of the first cell or cell group; an identity of the mobility configuration parameter; or a cause of failure.

Optionally, the chip further includes a memory 1503 used for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

An embodiment of the disclosure also provides a failure processing system. The system includes a communication apparatus as a terminal device and a communication apparatus as a network side device in the aforementioned embodiment of FIG. 13, or the system includes a communication apparatus as a terminal device and a communication apparatus as a network side device in the aforementioned embodiment of FIG. 14.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer programs on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device such as a server and a data center integrated by one or more usable mediums. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The term “predefine” in this disclosure may be understood as define, define in advance, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The above implementations are only specific implementations of the disclosure, but the scope of protection of the disclosure is not limited thereto. Those skilled in the art familiar to this technical field can easily think of changes or substitutions in the technical scope disclosed by the disclosure, which shall be covered by the scope of protection of the disclosure. Therefore, the scope of protection of the disclosure shall be governed by the scope of protection of the stated claims.

1. A failure processing method, performed by a terminal device, comprising:
receiving configuration information of at least one cell or cell group sent by a network side device;
reading the configuration information;
determining a reading failure for the configuration information; and
performing a process corresponding to the reading failure.

2. The method of claim 1, wherein receiving the configuration information of the at least one cell or cell group sent by the network side device comprises:
receiving mobility configuration information sent by the network side device, wherein the mobility configuration information comprises the configuration information of the at least one cell or cell group.

3. The method of claim 2, wherein
the mobility configuration information comprises a mobility configuration parameter corresponding to the at least one cell or cell group; and
the mobility configuration parameter of each cell or cell group comprises configuration information of the corresponding cell or cell group.

4. The method of claim 3, wherein performing the process corresponding to the reading failure comprises at least one of:
ignoring configuration information of a first cell or cell group configured by the network side device, wherein the first cell or cell group comprises one or more cells or cell groups for which the terminal device fails to read corresponding configuration information;
continuing to use configuration information stored in the terminal device;
sending indication information to the network side device, wherein the indication information is used to inform the network side device that the terminal device fails to read the configuration information or fails to reconfigure;
entering an idle state;
starting a radio resource control (RRC) reconstruction process; or
releasing a secondary cell group (SCG).

5. The method of claim 4, wherein ignoring the configuration information of the first cell or cell group configured by the network side device comprises at least one of:
ignoring a mobility configuration parameter corresponding to the first cell or cell group;
deleting the mobility configuration parameter corresponding to the first cell or cell group stored in the terminal device; or
prohibiting the terminal device from triggering access to the first cell or cell group according to the mobility configuration parameter corresponding to the first cell or cell group.

6. The method of claim 4, wherein continuing to use the configuration information having been stored in the terminal device comprises:
continuing to use a mobility configuration parameter corresponding to the first cell or cell group stored in the terminal device; or
continuing to use configuration information of the corresponding cell or cell group included in the mobility configuration parameter, and
updating other configuration information included in the mobility configuration parameter.

7. The method of claim 4, wherein the indication information comprises at least one of:
an identity of the first cell or cell group;
configuration information of the first cell or cell group;
a configuration information identity of the first cell or cell group;
a mobility configuration parameter of the first cell or cell group;
an identity of the mobility configuration parameter; or
a cause of failure.

8. The method of claim 4, wherein
the indication information is used to instruct the terminal device to ignore the configuration information of the first cell or cell group; and/or
the indication information is used to indicate whether the terminal device continues to use the configuration information stored in the terminal device.

9. The method of claim 1, further comprising:
determining the configuration information having been stored in the terminal device before receiving a reconfiguration message sent by the network side device.

10. A failure processing method, performed by a network side device, comprising:
sending configuration information of at least one cell or cell group to a terminal device.

11. The method of claim 10, wherein sending the configuration information of the at least one cell or cell group to the terminal device, comprises:
sending mobility configuration information to the terminal device, wherein the mobility configuration information comprises the configuration information of the at least one cell or cell group.

12. The method of claim 11, wherein
the mobility configuration information comprises a mobility configuration parameter corresponding to the at least one cell or cell group; and
the mobility configuration parameter of each cell or cell group comprises configuration information of the corresponding cell or cell group.

13. The method of claim 10, further comprising:
receiving indication information sent by the terminal device;
wherein the indication information is used to inform the network side device that the terminal device fails to read the configuration information or fails to reconfigure.

14. The method of claim 13, further comprising:
reconfiguring configuration information of a first cell or cell group, wherein the first cell or cell group comprises one or more cells or cell groups for which the terminal device fails to read corresponding configuration information; or
determining whether the terminal device currently stores the configuration information of the first cell or cell group; or,
determining whether the terminal device currently uses the configuration information of the first cell or cell group that has been stored.

15. The method of claim 13, wherein the indication information comprises at least one of:
an identity of the first cell or cell group;
configuration information of the first cell or cell group;
a configuration information identity of the first cell or cell group;
a mobility configuration parameter of the first cell or cell group;
an identity of the mobility configuration parameter; or
a cause of failure.

16. The method of claim 14, wherein
the indication information is used to instruct the terminal device to ignore the configuration information of the first cell or cell group; and/or
the indication information is used to indicate whether the terminal device continues to use the configuration information stored in the terminal device.

17. (canceled)

18. (canceled)

19. A terminal device, comprising a processor and a memory with a computer program stored thereon, wherein the processor is configured to:
receive configuration information of at least one cell or cell group sent by a network side device;
read the configuration information;
determine a reading failure for the configuration information; and
perform a process corresponding to the reading failure.

20. A computer-readable storage medium for storing instructions, wherein when the instructions are executed, the method of claim 1 is implemented.

21. A network side device, comprising a processor and a memory with a computer program stored thereon, wherein the processor is configured to cause the device to execute the method of claim 10 when executing the computer program stored on the memory.

22. A computer-readable storage medium for storing instructions, wherein when the instructions are executed, the method of claim 10 is implemented.
